(19) United States
(12) Patent Application Publication
(10) Pub. No.: US 2026/0122302 A1
(43) Pub. Date: Apr. 30, 2026

(54) TECHNIQUES FOR INTEGRATING CUSTOM ADVERTISING WHEN STREAMING LIVE EVENTS

(71) Applicant: NETFLIX, INC., Los Gatos, CA (US)

(72) Inventors: Zhi LI, Mountain View, CA (US); Joel SOLE ROJALS, San Diego, CA (US); Weiguo ZHENG, San Jose, CA (US)

(21) Appl. No.: 19/195,370

(22) Filed: Apr. 30, 2025

Related U.S. Application Data
(60) Provisional application No. 63/711,598, filed on Oct. 24, 2024.

(51) Int. Cl. H04N 21/2668; H04N 21/2187; H04N 21/81

(52) U.S. Cl. CPC H04N 21/2668; H04N 21/2187; H04N 21/812

(57) ABSTRACT

In various embodiments, custom video feeds are generated for live events. Prior to a live event, multiple enhancement streams are generated based on multiple enhancement video inputs. During the live event, a video stream is generated based on a live video feed of the live event. During the live event, the video stream and a first enhancement stream are transmitted to a first endpoint device, where a first custom video feed associated with the live event is generated and played back by the first endpoint device. During the live event, the video stream and a second enhancement stream are transmitted to a second endpoint device, where a second custom video feed associated with the first live event is generated and played back by the second endpoint device.

### CROSS-REFERENCE TO RELATED APPLICATIONS

This application claims priority benefit of the United States Provisional Patent Application titled, “TECHNIQUES FOR DISPLAYING LOCALIZED CONTENT VIA SCALABLE VIDEO STREAMS,” filed on Oct. 24, 2024 and having Ser. No. 63/711,598. The subject matter of this related application is hereby incorporated herein by reference.

### BACKGROUND

### Field of the Various Embodiments

The various embodiments relate generally to computer science and media streaming technologies and, more specifically, to techniques for integrating custom advertising when streaming live events.

### Description of the Related Art

In some approaches to streaming live events to televisions and other endpoint devices, a live video feed is encoded in real-time or near real-time to generate a video stream that includes encoded video content. Throughout the live event, the video stream is transmitted to any number of endpoint devices. Each endpoint device decodes the video stream and plays back the resulting reconstructed version of the live video feed, thereby enabling users to view the live event in near real-time.

Oftentimes, the users that stream a live event are located in disparate geographic locations, may speak different languages, and have a wide variety of individual preferences. For this reason, sometimes a live video feed is modified to generate multiple different custom video feeds, where each custom video feed includes integrated advertising that conforms more to the individual preferences of a given target audience. In this type of approach, each custom video feed is encoded to generate a different custom video stream that is transmitted to the endpoint devices associated with the given target audience for that particular custom video feed. For example, in a situation where different brands of soda are popular in different geographic locations, then custom video feeds of a soccer match could be generated for the different geographic locations, where the custom video feed for a given geographic location could include stadium advertising boards featuring the particular brand of soda popular in that given geographic location. In such an approach, the custom video feed for each given geographic location would be encoded and transmitted to the endpoint devices located within the given geographic location.

One drawback of the above approach is that encoding the different custom video feeds requires substantial processing resources and, therefore, can be very time-consuming. As a result, generating more than a handful of different custom video streams in real-time or near real-time can be extremely difficult, if not impossible. In this regard, attempting to encode more than a handful of custom video feeds while streaming a live event can introduce a long “stream delay” between the time a given event actually occurs during the live event and the time when that same event is displayed to a viewer of the live event. A long stream delay can make it difficult to follow a streamed live event in real-time or near real-time, and can therefore degrade the viewing experience. For example, a viewer could receive a phone notification of a goal scored during a soccer game noticeably before viewing the goal via an endpoint device that is experiencing a long stream delay while streaming the soccer game.

To reduce stream delays, oftentimes the number of different custom video streams derived from a single live video feed can be limited to a small number of custom video streams. The small number of custom video streams increase the likelihood that the preferences of a given user are not captured in any of the custom video streams. Therefore the effectiveness of integrated advertising with respect to the given user is likely to be subpar. Further exacerbating attempts to deliver custom streams to different groups of users is that endpoint devices implement widely varying processing capabilities, where some endpoint devices may not be able to perform the video processing techniques necessary to effect customization.

As the foregoing illustrates, what is needed in the art are more effective techniques for integrating custom advertising when streaming live events.

### SUMMARY

One embodiment sets forth a computer-implemented method for generating custom video feeds for live events. The method includes, prior to a first live event, generating a plurality of enhancement streams based on enhancement video inputs; during the first live event, generating a first video stream based on a first live video feed of the first live event; during the first live event, transmitting the first video stream and a first enhancement stream included in the enhancement streams to a first endpoint device, where the first endpoint device generates and plays back a first custom video feed associated with the first live event; and during the first live event, transmitting the first video stream and a second enhancement stream included in enhancement streams to a second endpoint device, where the second endpoint generates and plays back a second custom video feed associated with the first live event.

At least one technical advantage of the disclosed techniques relative to the prior art is that, with the disclosed techniques, different advertising video inputs can be encoded prior to a live event and then individually blended with a video stream during the live event to generate different custom video streams for the live event. In that regard, only a single live video feed is encoded during the live event in order to generate any number of custom video streams. Consequently, stream delays introduced when generating the custom video streams can be significantly reduced relative to prior art techniques. Another advantage of the disclosed techniques is that because a substantially greater number of custom video streams for a live event can be generated in real-time or near real-time, the likelihood that the preferences of individual users are reflected in the custom video streams can be increased. More specifically, with the disclosed techniques, each different encoded advertising input is transmitted along with the video stream to any number of compliant endpoint devices associated with a target audience for that particular encoded advertising input, where each compliant endpoint device is capable of generating, decoding, and playing back a corresponding custom video stream. And, with the disclosed techniques, each custom video stream can be generated and transcoded, where the resulting integrated video stream can be transmitted to any number of less capable, non-compliant endpoint devices for decoding and playback. These technical advantages provide one or more technical advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the custom decoding application of FIG. 1, according to various embodiments;

FIG. 3 is a more detailed illustration of the transcoding cluster of FIG. 1, according to various embodiments;

FIG. 4 is a flow diagram of method steps for integrating custom advertising into custom video feeds when streaming live events, according to various embodiments;

FIG. 5 is a flow diagram of method steps for generating different integrated video streams corresponding to different enhancement streams when streaming live events, according to various embodiments; and

FIG. 6 is a flow diagram of method steps for decoding a video stream and an enhancement stream to generate a custom video feed, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances or versions of like objects are denoted with reference numbers identifying the object and parenthetical numbers identifying the instance where needed.

To increase the effectiveness of advertising when streaming a live event, a streaming video provider can modify a live video feed of the live event to generate multiple different custom video feeds, where each custom video feed includes integrated advertising that is intended to appeal to a different target audience. The streaming video provider then encodes each custom video feed to generate a custom video stream that is transmitted to endpoint devices associated with the target audience for that particular custom video feed.

One drawback of the above approach is that encoding the different custom video feeds requires substantial processing resources and, therefore, can be very time-consuming. As a result, generating more than a handful of different custom video streams without introducing a significant delay between the time a given event actually occurs during the live event and the time when that same event is displayed to a viewer streaming the live event can be extremely difficult, if not impossible. To reduce these types of stream delays, a streaming video provider typically derives only a small number of custom video streams from a single live video feed. However, limiting the number of custom video streams in this fashion increases the likelihood that the preferences of a given user are not captured in any of the custom video streams and therefore decreases the effectiveness of the integrated advertising with respect to that user.

With the disclosed techniques, however, a scalable encoding application encodes each of multiple advertising video inputs in conjunction with an associated blending input and a placeholder video input to generate an associated enhancement stream prior to a live event. The blending input associated with an advertising input includes alpha values that indicate a degree of transparency of that advertising input relative to a live video stream of the live event. The placeholder video input can be any video input (e.g., a sequence of black frames). Each enhancement stream includes a different texture enhancement layer, a different alpha enhancement layer, and a placeholder base layer that are encoded versions of, respectively, the associated advertising video input, the associated blending input, and the placeholder video input. Also prior to the live event, a manifest application generates a different custom stream definition for each enhancement stream. The custom stream definition for an enhancement stream specifies a custom video stream that includes the texture enhancement layer from the enhancement stream, the alpha enhancement layer from the enhancement stream, and a base layer from a video stream that is to be generated during the live event. During the live event, the scalable encoding application encodes a live video feed of the live event to generate the video stream.

“Compliant” endpoint devices are endpoint devices that are capable of generating custom video streams as per custom stream definitions. To enable a compliant endpoint device to stream the live event, the manifest application selects and transmits to the compliant endpoint device a custom stream definition that is associated with the same target audience as that endpoint device. During the live event, the compliant endpoint device generates the custom video stream specified in the custom stream definition based on the specified enhancement stream and the video stream. More precisely, the compliant endpoint device replaces the placeholder base layer included in the specified enhancement stream with the base layer included in the video stream to generate the custom video stream associated with the same target audience as the compliant endpoint device. The compliant endpoint device decodes the different layers in the custom video stream and blends a decoded texture enhancement layer with a decoded base layer using a decoded alpha enhancement layer to generate a custom video feed. The compliant endpoint device plays back the custom video feed that includes integrated advertising that properly targets the audience associated with the compliant endpoint device.

To support non-compliant endpoint devices, a transcoding cluster generates and decodes each custom video stream based on the associated custom stream definition, the associated enhancement stream, and the video stream. The transcoding cluster encodes each custom video stream to generate an integrated video stream that includes a single layer. Each integrated video stream is transmitted to non-compliant endpoint devices associated with the target audience for the integrated video stream for conventional decoding and playback.

At least one technical advantage of the disclosed techniques relative to the prior art is that, because only a single live video feed is encoded during the live event in order to generate any number of custom video streams, stream delays can be significantly reduced relative to prior art techniques. Another advantage of the disclosed techniques is that because a substantially greater number of custom video streams for a live event can be generated in real-time or near real-time, the likelihood that the preferences of individual users are reflected in the custom video streams can be increased. And, with the disclosed techniques, each custom video stream can be generated and transcoded to generate an integrated video stream that can be transmitted to non-compliant endpoint devices for decoding and playback. These technical advantages provide one or more technical advancements over prior art approaches.

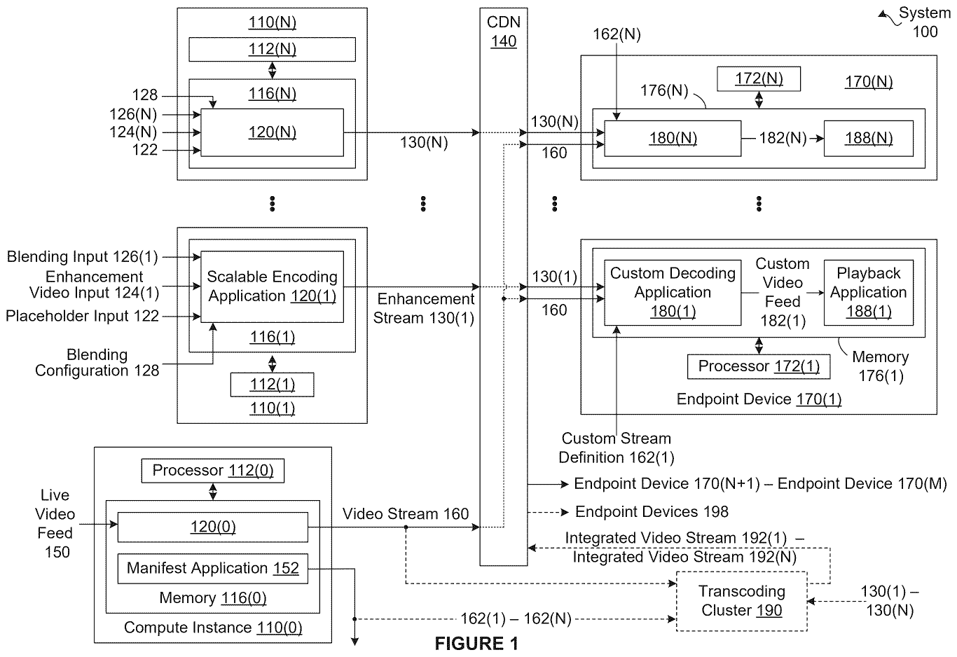

FIG. 1 is a conceptual illustration of a system 100 configured to implement one or more aspects of the various embodiments. As shown, in some embodiments, the system 100 includes, without limitation, a compute instance 110(0)—a compute instance 110(N), a content delivery network (CDN) 140, and an endpoint device 170(1)—an endpoint device 170(M), where N is a positive integer and M is an integer that is greater than N. As depicted with dashed boxes and dashed arrows, in some embodiments, the system 100 further includes, without limitation, a transcoding cluster 190 and endpoint devices 198. In the same or other embodiments, the system 100 can omit the CDN 140.

For explanatory purposes, the compute instance 110(0)—the compute instance 110(N) are also referred to herein individually as a “compute instance 110” and collectively as “compute instances 110.” The endpoint device 170(1)—the endpoint device 170(M) are also referred to herein individually as an “endpoint device 170” and collectively as “endpoint devices 170.”

Any number of the components of the system 100 can be distributed across multiple geographic locations or implemented in one or more cloud computing environments (e.g., encapsulated shared resources, software, data) in any combination. In some embodiments, any number of the compute instances 110, any number of other compute instances, the transcoding cluster 190, or any combination thereof can be implemented in a cloud computing environment, implemented as part of any other distributed computing environment, or implemented in a stand-alone fashion.

As shown, in some embodiments, the compute instance 110(0) includes, without limitation, a processor 112(0) and a memory 116(0). The compute instance 110(1) includes, without limitation, a processor 112(1) and a memory 116(1). And the compute instance 110(N) includes, without limitation, a processor 112(N) and a memory 116(N). Although not shown, each of the compute instance 110(2)—the compute instance 110(N−1) includes, without limitation, at least one processor and at least one memory.

In some embodiments, each compute instance 110 can include any number of processors 112 and any number of memories 116 in any combination. In particular, any number of compute instances 110 (including one) can provide any number of multiprocessing environments in any technically feasible fashion. The processor 112(0), the processor 112(1), the processor 112(N), and any other processors included in the compute instances 110 are also referred to herein individually as a “processor 112” and collectively as “processors 112.” The memory 116(0), the memory 116(1), the memory 116(N), and any other memories included in the compute instances 110 are also referred to herein individually as a “memory 116” and collectively as “memories 116.”

Each processor 112 can be any instruction execution system, apparatus, or device capable of executing instructions. For example, each processor 112 could comprise a central processing unit, a graphics processing unit, a controller, a microcontroller, a state machine, or any combination thereof. The memory 116 of each compute instance 110 stores content, such as software applications and data, for use by the processor 112 of the compute instance 110.

Each memory 116 can be one or more of any readily available memory, such as random access memory, read-only memory, floppy disk, hard disk, or any other form of digital storage, local or remote. In some embodiments, a storage (not shown) may supplement or replace any number of memories 116. The storage can include any number and/or types of external memories that are accessible to any number of processors 112. For example, and without limitation, the storage can include a Secure Digital Card, an external Flash memory, a portable compact disc read-only memory, an optical storage device, a magnetic storage device, or any suitable combination of the foregoing.

In general, each of the compute instances 110 is configured to implement one or more software applications. For explanatory purposes only, each software application is described as residing in the memory 116 of a single compute instance and executing on the processor 112 of the same compute instance. However, in some embodiments, the functionality of each software application can be distributed across any number of other software applications that reside in the memories of any number of compute instances or other components of the system 100 and execute on the processors of any number of compute instances or other components of the system 100 in any combination. Further, subsets of the functionality of multiple software applications can be consolidated into a single software application.

For explanatory purposes, the functionality of the system 100 is described below in the context of integrating custom advertising into a video stream 160 derived from a live video feed 150 of a live event to the endpoint devices 170 and optionally the endpoint devices 198 via the CDN 140. Note, however, that the techniques described herein are illustrative rather than restrictive. Many modifications and variations will be apparent to those of ordinary skill in the art without departing from the scope and spirit of the described embodiments and techniques.

In particular, in some embodiments, the techniques described herein can be modified to integrate custom advertising into multiple video streams derived from the live video feed 150, where each video stream is associated with a different combination of bitrate and resolution. In the same or other embodiments, the techniques described herein can be modified and applied to streaming any number of live video feeds of any number of live events to any number and/or types of endpoint devices.

Some examples of live events are a live sporting event, a live television show, a live performance, a live speech, and a live meeting. A live video feed of a live event delivers video content associated with the live event in real-time or near real-time. Each live event can be associated with any number of different live video feeds, where each live video feed is associated with a different source (e.g., recorded by a different camera).

As described previously herein, in one conventional approach to integrating custom advertising when streaming a live event, a live video feed is modified to generate multiple different custom video feeds. Each custom video feed includes integrated advertising that conforms more to the individual preferences of a different target audience. Each custom video feed is encoded to generate a different custom video stream that is transmitted to the endpoint devices associated with the target audience for that particular custom video feed.

One drawback of the above conventional approach is that encoding the different custom video feeds requires substantial processing resources and, therefore, can be very time-consuming. As a result, attempting to encode more than a handful of custom video feeds while streaming a live event can introduce a long stream delay that can make it difficult to follow a streamed live event in real-time or near real-time. To reduce stream delays, oftentimes the number of different custom video streams derived from a single live video feed can be limited to a small number of custom video streams. The small number of custom video streams increase the likelihood that the preferences of a given user are not captured in any of the custom video streams. Further exacerbating attempts to deliver custom streams to different target audiences is that endpoint devices implement widely varying processing capabilities, where some endpoint devices may not be able to perform the video processing techniques necessary to effect customization.

### Encoding Different Enhancement Video Inputs Prior to a Live Event

To address the above problems, the compute instance 110(1)—the compute instance 110(N) are configured to generate, respectively, enhancement stream 130(1)—enhancement stream 130(N) prior to the live event. During the live event, the compute instance 110(0) generates a video stream 160 based on the live video feed 150. During the live event, each of the enhancement stream 130(1)—the enhancement stream 130(N) can be individually blended with the video stream 160 in real-time or near real-time to generate different custom video streams for the live event. Advantageously, with the disclosed techniques, only the video stream 160 is encoded during the live event to generate any number of custom video streams associated with the live event. Consequently, stream delays introduced when generating the custom video streams can be significantly reduced relative to prior art techniques. Furthermore, because a substantially greater number of custom video streams for a live event can be generated in real-time or near real-time, the likelihood that the preferences of individual users are reflected in the custom video streams can be increased.

As shown, the compute instance 110(0)—the compute instance 110(N) implement a scalable encoding application 120(0)—a scalable encoding application 120(N), respectively. As shown, the scalable encoding application 120(0) resides in the memory 116(0) of the compute instance 110(0) and executes on the processor 112(0) of the compute instance 110(0). The scalable encoding application 120(1) resides in the memory 116(1) of the compute instance 110(1) and executes on the processor 112(1) of the compute instance 110(1). The scalable encoding application 120(N) resides in the memory 116(N) of the compute instance 110(N) and executes on the processor 112(N) of the compute instance 110(N). Although not shown, for a variable integer x from 2 through N−1, the scalable encoding application 120(x) resides in the memory 116 of the compute instance 110(x) and executes on the processor 112 of the compute instance 110(x).

Each of the scalable encoding application 120(0)—a scalable encoding application 120(N) is a different instance of a scalable encoding application 120 (not explicitly shown). The scalable encoding application 120 implements encoding techniques that are associated with (e.g., based, at least in part, on) a video coding specification for a coder/decoder (codec) and/or a video format that has support for multi-layer streams. Video coding specifications are also commonly referred to as “video codec specifications.” For instance, in some embodiments, scalable encoding application 120 implements encoding techniques that are associated with an Alliance for Open Media Video 1 (AV1) with Scalable Video Coding (SVC) capabilities or “AV1-SVC” video coding specification.

Prior to the live event, the scalable encoding application 120(1)—the scalable encoding application 120(N) generate the enhancement stream 130(1)—the enhancement stream 130(N), respectively, based on an enhancement video input 124(1)—an enhancement video input 124(N), respectively. More precisely, as shown, the scalable encoding application 120(1) performs one or more encoding operations on the enhancement video input 124(1), a blending input 126(1), and a placeholder input 122 in accordance with a blending configuration 128 to generate the enhancement stream 130(1). As also shown, the scalable encoding application 120(N) performs one or more encoding operations on the enhancement video input 124(N), a blending input 126(N), and the placeholder input 122 in accordance with the blending configuration 128 to generate the enhancement stream 130(N). Although not shown, for a variable integer x from 2 through N−1, the scalable encoding application 120(x) performs one or more encoding operations on the enhancement video input 124(x), a blending input 126(x), and the placeholder input 122 in accordance with the blending configuration 128 to generate the enhancement stream 130(x).

The enhancement video input 124(1)—the enhancement video input 124(N) are also referred to herein individually as an “enhancement video input 124” and collectively as “enhancement video inputs 124.” The blending input 126(1)—the blending input 126(N) are also referred to herein individually as a “blending input 126” and collectively as “blending inputs 126.” The enhancement stream 130(1)—the enhancement stream 130(N) are also referred to herein individually as an “enhancement stream 130” and collectively as “enhancement streams 130.”

Each of the enhancement video inputs 124 includes, without limitation, different video content. In particular, in some embodiments, each of the enhancement video inputs 124 includes different advertising content that is to be integrated into video content included in the live video feed 150. In some other embodiments, each of the enhancement video inputs 124 can include any amount and/or types of video content that is to be integrated into any number of live video feeds associated with any number of live events. For example, each of the enhancement video inputs 124 could include information in a different language that is to be integrated into a scoreboard of a sporting event associated with the live video feed 150.

As persons skilled in the art will recognize, video content includes, without limitation, any number of frames. In some embodiments, each frame of video content includes, without limitation, any number of samples corresponding to a rectangular region of pixels. As used herein, a “sample” is an intersection of a channel and a pixel. A YCbCr color space includes a luma (Y) channel and two chroma channels denoted Cb and Cr. Accordingly, if a frame represents pixels in the YCbCr color space, then the frame includes Y samples, Cb samples, and Cr samples. An RGB color space includes a red (R) channel, a green (G) channel, and a blue (B) channel. Accordingly, if a frame represents pixels in the RGB color space, then the frame includes R samples, G samples, and B samples.

The blending input 126(1)—the blending input 126(N) include, without limitation, transparency information associated with, respectively, the enhancement video input 124(1)—the enhancement video input 124(N). In some embodiments, the blending input 126(1)—the blending input 126(N) include, without limitation, a different frame for each frame of, respectively, the enhancement video input 124(1)—an enhancement video input 124(N). Each frame of each of the blending input 126(1)—the blending input 126(N) includes, without limitation, one or more samples for each pixel in the corresponding frame of, respectively, the enhancement video input 124(1)—the enhancement video input 124(N).

In some embodiments, each sample included in the blending input 126(1)—the blending input 126(N) is an alpha value. For a variable integer y from 1 through N, an alpha value included in the blending input 126(y) represents a degree of transparency (or opacity) for use in blending corresponding samples or corresponding pixels of corresponding frames between respectively, the enhancement video input 124(y) and the video stream 160. Accordingly, the blending input 126(y) represents at least one of per-pixel or per-sample transparency information associated with the enhancement video input 124(y).

The blending configuration 128 indicates a blending process that is to be applied during decoding. Some examples of blending processes are, without limitation, a premultiplied alpha blending process in the YCbCr color space, a straight alpha blending process in the YCbCr color space, and a straight alpha blending process in the RGB color space. In a premultiplied alpha blending process, the enhancement video input 124(1)—the enhancement video input 124(N) are modified based on, respectively, the blending input 126(1)—the blending input 126(N) prior to encoding. In a straight alpha blending process, the enhancement video inputs 124 are not modified prior to encoding. As described in greater detail below, the placeholder input 122 includes any background video content (e.g., black frames) that is to be replaced or discarded prior to decoding.

As referred to herein, a “stream” includes, without limitation, at least one encoded version of at least one video source, optionally encoded versions of any amount and/or types of associated data (e.g., the blending input 126), and optionally any amount and/or types of associated metadata. Some examples of video sources are the enhancement video inputs 124 and the live video feed 150. Each stream that is derived from a video source includes, without limitation, a sequence of one or more discrete, time-based segments that correspond (in a playback timeline) to a sequence of one or more discrete portions of the video source. For explanatory purposes, a “segment” as used herein refers to a segment of a stream.

Although not shown in FIG. 1, each of enhancement streams 130 includes, without limitation, a different alpha enhancement layer, a different texture enhancement layer, a different placeholder base layer, and different blending metadata. More specifically, for a variable integer y from 1 through N, the enhancement stream 130(y) includes, without limitation, an alpha enhancement layer that is an encoded version of the blending input 126(y), a texture enhancement layer that is an encoded version of the enhancement video input 124(y), a base layer that is an encoded version of the placeholder input 122(y), and blending metadata that reflects the blending configuration 128. The enhancement stream 130(1) is described in greater detail below in conjunction with FIG. 1.

As shown, throughout the live event, the scalable encoding application 120(0) performs one or more encoding operations on the live video feed 150 to generate the video stream 160. More specifically, throughout the live event, the scalable encoding application 120(0) periodically generates different segments of the video stream 160 based on the live video feed 150 of the live event.

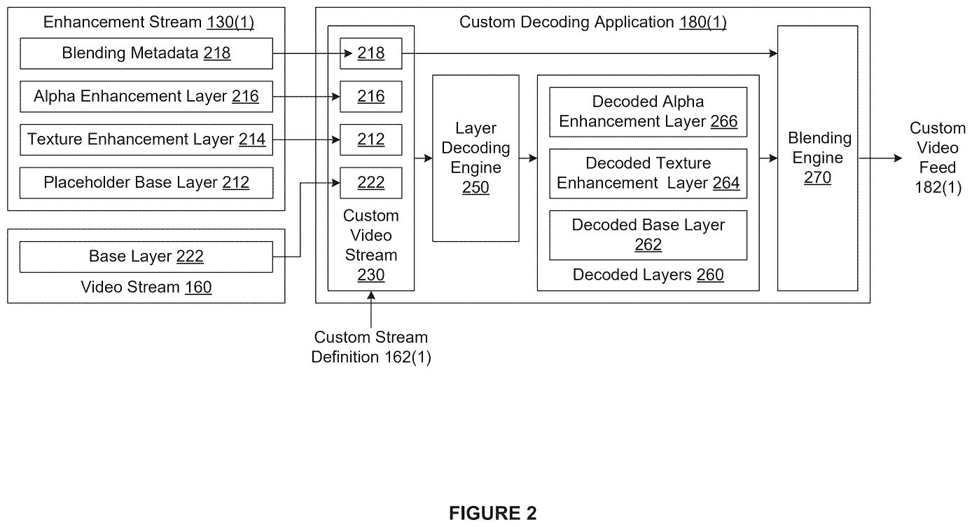

As described in greater detail below in conjunction with FIG. 2, the video stream 160 includes, without limitation, a base layer and is associated with the same video coding specification as the enhancement streams 130. The base layer includes an encoded version of video content included in the video stream 160. The scalable encoding application 120(0) can be configured to generate the video stream 160 that includes a single layer and is associated with the same video coding specification as the enhancement streams 130 that each include multiple layers in any technically feasible fashion.

As shown, a manifest application 152 resides in the memory 116(0) of the compute instance 110(0) and executes on the processor 112(0) of the compute instance 110(0). Prior to the live event, the manifest application 152 generates a custom stream definition 162(1)—a custom stream definition 162(N) that define different custom video streams derived from the video stream 160 that is to be generated during the live event. The custom stream definition 162(1)—a custom stream definition 162(N) are also referred to herein individually as a “custom stream definition 162” and collectively as “custom stream definitions 162.”

For a variable integer y from 1 through N, the custom stream definition 162(y) indicates that an associated custom video stream is to include a base layer from the video stream 160, blending metadata from the enhancement stream 130(y), an alpha enhancement layer from the enhancement stream 130(y), and a texture enhancement layer from the enhancement stream 130(y). For instance, the custom stream definition 162(1) indicates that an associated custom video stream is to include the base layer from the video stream 160, the blending metadata from the enhancement stream 130(1), the alpha enhancement layer from the enhancement stream 130(1), and the texture enhancement layer from the enhancement stream 130(1). And the custom stream definition 162(N) indicates that an associated custom video stream is to include the base layer from the video stream 160, the blending metadata from the enhancement stream 130(N), the alpha enhancement layer from the enhancement stream 130(N), and the texture enhancement layer from the enhancement stream 130(N).

As shown, prior to the live event, the scalable encoding application 120(1)—the scalable encoding application 120(N) transmit the enhancement streams 130 to the CDN 140. During the live event, as the scalable encoding application 120(0) generates each segment of the video stream 160, the scalable encoding application 120(0) transmits the segment of the video stream 160 to the CDN 140. The CDN 140 stores and transmits or “delivers” on-demand segments of the enhancement streams 130 and segments of the video stream 160 to the endpoint devices 170.

Each of the endpoint device 170 can be any type of device that includes at least one processor and one memory and is capable of generating, decoding, and playing back custom video streams as specified in the custom stream definitions 162. The endpoint devices 170 are also referred to herein as “compliant” endpoint devices. Some examples of compliant endpoint devices include, without limitation, desktop computers, laptops, smartphones, smart televisions, game consoles, tablets, and set-top boxes that implement instances of a custom decoding application 180 (not explicitly shown).

Prior to or during the live event, to enable a compliant endpoint device (e.g., one of the endpoint devices 170) to stream the live event, the manifest application 152 selects one of the custom stream definitions 162 based on a target audience associated with that compliant endpoint device and transmits the selected custom stream definition to that compliant endpoint device. To enable a compliant endpoint device to stream the live event, the manifest application selects and transmits to the compliant endpoint device a custom stream definition that is associated with the same target audience as that endpoint device. Throughout the live event, the compliant endpoint device requests and receives from the CDN 140 segments of the video stream 160 and corresponding segments of the enhancement stream 130 specified in the selected custom stream definition. The compliant endpoint device generates a custom video stream in accordance with the selected custom stream definition. The compliant endpoint device decodes the different layers in the custom video stream and blends a decoded texture enhancement layer with a decoded base layer using a decoded alpha enhancement layer to generate a custom video feed. The compliant endpoint device plays back the custom video feed that includes integrated advertising that properly targets the audience associated with the compliant endpoint device.

As shown, in some embodiments, the endpoint device 170(1) includes, without limitation, a processor 172(1) and a memory 176(1). As also shown, the endpoint device 170(N) includes, without limitation, a processor 112(N) and a memory 116(N). Although not shown, each of the endpoint device 170(2)—the endpoint device 170(N−1) and each of the endpoint device 170(N+1)—the endpoint device 170(M) includes, without limitation, at least one processor and at least one memory.

The processor 172(1), the processor 172(N), and any other processors included in the endpoint devices 170 are also referred to herein individually as a “processor 172” and collectively as “processors 172.” The memory 176(1), the memory 176(N), and any other memories included in the endpoint devices 170 are also referred to herein individually as a “memory 176” and collectively as “memories 176.” Each processor 172 can be any instruction execution system, apparatus, or device capable of executing instructions. The memory 176 of each endpoint device 170 stores content, such as software applications and data, for use by the processor 172 of the endpoint device 170. Each memory 176 can be one or more of any readily available memory, such as random access memory, read-only memory, floppy disk, hard disk, or any other form of digital storage, local or remote. In some embodiments, a storage (not shown) may supplement or replace any number of memories 176. The storage can include any number and/or types of external memories that are accessible to any number of processors 172.

In general, each of the endpoint devices 170 is configured to implement one or more software applications. As shown, in some embodiments, a custom decoding application 180(1) and a playback application 188(1) reside in the memory 176(1) of the endpoint device 170(1) and execute on the processor 172(1) of the endpoint device 170(1). As also shown, a custom decoding application 180(N) and a playback application 188(N) reside in the memory 176(N) of the endpoint device 170(N) and execute on the processor 172(N) of the endpoint device 170(N). Although not shown, for a variable integer x from 2 through N−1 and from (N+1) through M, a custom decoding application 180(x) and a playback application 188(x) reside in a memory 176(x) of the endpoint device 170(x) and execute on a processor 172(x) of the endpoint device 170(x). Each of the custom decoding application 180(1)—the custom decoding application 180(M) is a different instance of the custom decoding application 180. Each of the playback application 188(1)—the playback application 188(M) is a different instance of a playback application 188 (not explicitly shown).

For explanatory purposes only, the functionality of the system 100 is described and depicted in greater detail in FIG. 1 in the context of streaming the live event with different integrated advertising to each of the endpoint device 170(1)—the endpoint device 170(N). As shown, in some embodiments, the manifest application 152 transmits the custom stream definition 162(1)—the custom stream definition 162(N) to, respectively, the endpoint device 170(1)—the endpoint device 170(N) prior to the live event. Throughout the live event, the endpoint device 170(1)—the endpoint device 170(N) request from the CDN 140 segments of the video stream 160 and corresponding segments of, respectively, the enhancement stream 130(1)—the enhancement stream 130(N). In response, the CDN 140 transmits requested segments of the video stream 160 to the endpoint devices 170 and requested segments of the enhancement stream 130(1)—the enhancement stream 130(N) to, respectively, the endpoint device 170(1)—the endpoint device 170(N).

In this fashion, the custom decoding application 180(1)—the custom decoding application 180(N) acquire, respectively, the custom stream definition 162(1)—the custom stream definition 162(N), incrementally acquire the video stream 160, and incrementally acquire, respectively, the enhancement stream 130(1)—the enhancement stream 130(N). Throughout the live event, the custom decoding application 180(1)—the custom decoding application 180(N) generate, respectively, a custom video feed 182(1)—a custom video feed 182(N) in accordance with, respectively, the custom stream definition 162(1)—the custom stream definition 162(N).

For a variable integer y from 1 through N, the blending metadata included in the enhancement stream 130(y) and the alpha enhancement layer included in the enhancement stream 130(y) specify how to combine the base layer included in the video stream 160 and the texture enhancement layer specified in the enhancement stream 130(y) during decoding to generate the custom video feed 182(y). More precisely, in some embodiments, the blending metadata included in the enhancement stream 130(y) indicates a blending process that is to be performed between a decoded version of the base layer included in the video stream 160 and a decoded version of the texture enhancement layer specified in the enhancement stream 130(y) based on a decoded version of the alpha enhancement layer included in the enhancement stream 130(y). The functionality of the custom decoding application 180 is described in greater detail in the context of the custom decoding application 180(1) below in conjunction with FIG. 2.

Throughout the live event, the playback application 188(1)—the playback application 188(N) playback, respectively, the custom video feed 182(1)—a custom video feed 182(N). Importantly, each of the custom video feed 182(1)—the custom video feed 182(N) includes different integrated advertising. Advantageously, because the enhancement streams 130 are generated prior to the live event, only the live video feed 150 is encoded during the live event in order to generate the custom video feed 182(1)—a custom video feed 182(N).

Notably, the amount of processing resources required to generate the enhancement streams 130 can be substantially reduced relative to prior-art techniques. In that regard, prior-art techniques can require prohibitive amounts of processing resources to generate and coordinate the generation of the enhancement streams 130 in real-time. With the disclosed techniques, the enhancement streams 130 can be generated prior to the live event in parallel, sequentially, or any combination thereof, and over any period of time using substantially less processing resources.

As depicted with dashed arrows and dashed boxes, in some embodiments, the system 100 includes the endpoint devices 198 and the transcoding cluster 190. Each of the endpoint devices 198 can be any type of device that is not capable of generating custom video streams based on the custom stream definitions 162 but is capable of decoding and playing back “integrated” video streams that do not include multiple layers. The endpoint devices 198 are therefore less capable than the endpoint devices 170 (at least with respect to the custom stream definitions 162). The endpoint devices 198 are referred to herein as “non-compliant” endpoint devices. Advantageously, the transcoding cluster 190 enables the endpoint devices 198 and any other non-compliant endpoint devices to stream the live event.

As shown, during the live event, the transcoding cluster 190 generates and stores in the CDN 140 an integrated video stream 192(1)—an integrated video stream 192(N) based on the video stream 160, the enhancement streams 130, and the custom stream definitions 162. The integrated video stream 192(1)—the integrated video stream 192(N) are also referred to herein individually as an “integrated video stream 192” and collectively as “integrated video streams 192.” Each of the integrated video streams 192 includes a single layer and is associated with a video coding specification that is different from the video coding specification associated with the video stream 160 and the enhancement streams 130. In some alternate embodiments, the system 100 can include any number of transcoding clusters, where each transcoding cluster generates integrated video streams associated with a different video coding specification.

As shown, prior to the live event, the scalable encoding application 120(1)—the scalable encoding application 120(N) transmit, respectively, the enhancement stream 130(1)—the enhancement stream 130(N) to the transcoding cluster 190. Also prior to the live event, the manifest application 152 transmits the custom stream definitions 162 to the transcoding cluster 190. During the live event, the scalable encoding application 120(0) transmits segments of the video stream 160 to the transcoding cluster 190.

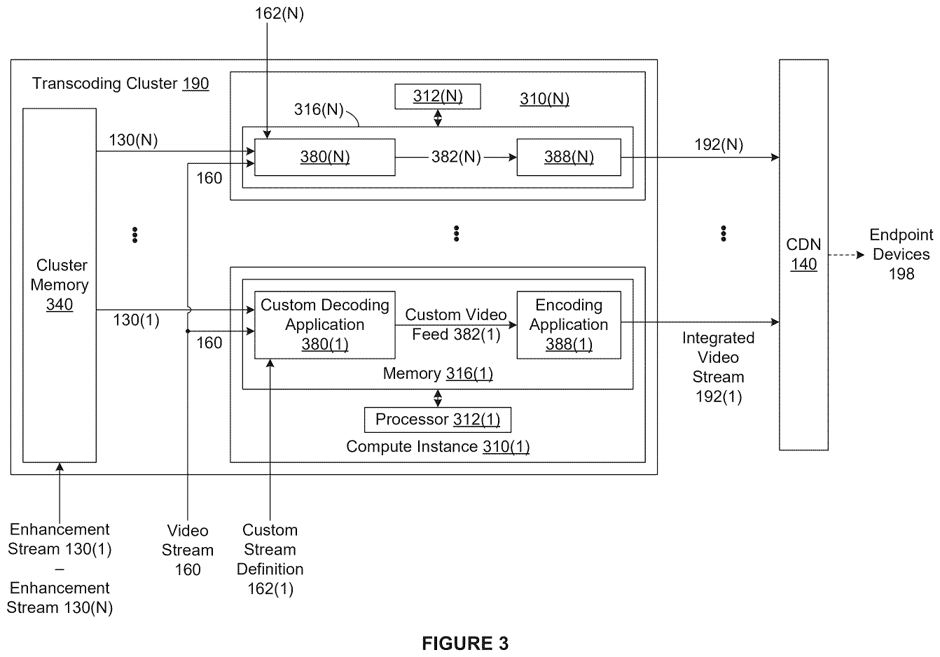

Throughout the live event, the transcoding cluster 190 generates segments of different custom video streams in accordance with the custom stream definitions 162. The transcoding cluster 190 decodes the segments of the custom video streams to generate corresponding portions of custom video feeds. In some embodiments, each custom video feed includes different integrated advertising content. The transcoding cluster 190 performs one or more encoding operations on the portions of the custom video feeds to generate corresponding segments of the integrated video streams 192. The transcoding cluster 190 transmits the segments of the integrated video streams 192 to the CDN 140. During the live event, the CDN 140 transmits segments of the integrated video streams 192 on-demand to the endpoint devices 198 for decoding and playback. The transcoding cluster 190 is described in greater detail below in conjunction with FIG. 3.

Note that the techniques described herein are illustrative rather than restrictive and can be altered without departing from the broader spirit and scope of the invention. Many modifications and variations on the functionality of the scalable encoding application 120, the manifest application 152, the custom decoding application 180, the playback application 188, and the transcoding cluster 190 as described herein will be apparent to those of ordinary skill in the art without departing from the scope and spirit of the described embodiments. For instance, in some embodiments, the scalable encoding application 120 generates encoded blending metadata instead of blending metadata, and the custom decoding application 180 and the transcoding cluster 190 implement any number and/or types of decoding techniques to generate blending metadata based on the encoded blending metadata.

In some embodiments, the scalable encoding application 120 performs one or more encoding operations on an enhancement video input and at least one of a blending input and the placeholder input 122 to generate an enhancement stream. In particular, in some embodiments, the scalable encoding application 120 generates an enhancement stream based on an enhancement video input, a blending input, and optionally the blending configuration 128; the scalable encoding application 120 does not use the placeholder input 122; and the placeholder input 122 can be omitted from the system 100.

In some embodiments, any number of video streams can be generated based on any number of live video feeds of any number of live events. In some such embodiments, the transcoding cluster 190 can acquire and transcode different combinations of the video streams and the enhancement streams 130 to generate any number of integrated custom feeds associated with any number of live events. In the same or other embodiments, different compliant endpoint devices can acquire and decode different combinations of one of the video streams and one of the enhancement streams 130 to generate different custom video feeds associated with any number of live events.

For instance, in some embodiments, the scalable encoding application 120 generates and stores in the CDN 140 a second video stream based on a second live video feed of a second live event. During the second live event, the CDN 140 transmits the second video stream and the enhancement stream 130(1) to the endpoint device 170(w). The custom decoding application 180(2) generates a custom video feed associated with the second live event based on the second video stream and the enhancement stream 130(1). The playback application 188(2) plays back the custom video feed associated with the second live event.

Similarly, many modifications and variations on the storage and delivery of the enhancement streams 130, the video stream 160, the integrated video streams 192, and the custom stream definitions 162 as described herein will be apparent to those of ordinary skill in the art without departing from the scope and spirit of the described embodiments. For instance, in some embodiments, the CDN 140 is replaced by any amount and/or types of storage, and the techniques described herein are modified accordingly. In some other embodiments, the CDN 140 transmits segments of the video stream 160 and/or segments of the enhancement streams 130 to the transcoding cluster 190 on-demand.

In some embodiments, any types of portions (e.g., segments, layers) of the enhancement streams 130, the video stream 160, the integrated video streams 192, or any combination thereof are stored and delivered to any number and/or types of devices in any technically feasible fashion. For instance, in some embodiments, enhancement layers included in the enhancement streams 130 but not placeholder base layers included in the enhancement streams 130 are stored in the CDN 140, and the techniques implemented by the custom decoding application 180 are modified accordingly.

It will be appreciated that the system 100 shown herein is illustrative and that variations and modifications are possible. For example, the functionality provided by the scalable encoding application 120, the manifest application 152, the custom decoding application 180, the playback application 188, the transcoding cluster 190, the compute instances 110, the endpoint devices 170, and the endpoint devices 198 as described herein can be integrated into or distributed across any number of software applications (including one), and any number of components of the system 100. Further, the connection topology between the various units in FIG. 1 can be modified as desired.

### Integrating Custom Advertising When Streaming a Live Event

FIG. 2 is a more detailed illustration of the custom decoding application 180(1) of FIG. 1, according to various embodiments. As described previously herein, the custom decoding application 180(1) is an instance of the custom decoding application 180. As shown, the custom decoding application 180(1) generates the custom video feed 182(1) based on the enhancement stream 130(1) and the video stream 160 in accordance with the custom stream definition 162(1). Notably, the enhancement stream 130(1) and the video stream 160 are both associated with the same video coding specification. For instance, in some embodiments, the video stream 160 and the enhancement stream 130(1) are both associated with the AV1-SVC video coding specification.

As shown, the enhancement stream 130(1) is a multi-layer stream that includes, without limitation, a placeholder base layer 212, a texture enhancement layer 214, an alpha enhancement layer 216, and blending metadata 218. As used herein, the blending metadata 218 includes any amount and/or types of metadata relevant to multi-layer blending. For instance, in some embodiments, the blending metadata 218 describes a blending process that involves one or more of the layers included in the enhancement stream 130(1). The blending metadata 218 is described in greater detail below. As described previously herein in conjunction with FIG. 1, the enhancement stream 130(1) is pregenerated prior to the live event associated with the video stream 160.

As shown, the video stream 160 includes, without limitation, a base layer 222. As described previously herein in conjunction with FIG. 1, the video stream 160 is incrementally generated throughout the live event based on the live video feed 150 (not shown in FIG. 2) of the live event. More specifically, in some embodiments, the scalable encoding application 120(0) sequentially encodes portions of the live video feed 150 to generate a sequence of segments included in the video stream 160.

The custom stream definition 162(1) specifies that a custom video stream 230 is to include the base layer 222 from the video stream 160, the blending metadata 218 from the enhancement stream 130(1), the alpha enhancement layer 216 from the enhancement stream 130(1), and the texture enhancement layer 214 from the enhancement stream 130(1).

As shown, the custom decoding application 180(1) includes, without limitation, a layer decoding engine 250 and a blending engine 270. The custom decoding application 180(1) generates a custom video stream 230 based on the video stream 160 and the enhancement stream 130(1) in accordance with the custom stream definition 162(1). Importantly, the custom video stream 230 is associated with the same video encoding specification as the enhancement stream 130(1) and the video stream 160. The custom decoding application 180(1) can generate the custom video stream 230 in any technically feasible fashion.

For instance, in some embodiments, the custom decoding application 180(1) aggregates the base layer 222, the blending metadata 218, the alpha enhancement layer 216, and the texture enhancement layer 214 to generate the custom video stream 230. In some other embodiments, the custom decoding application 180(1) replaces the placeholder base layer 212 included in enhancement stream 130(1) with the base layer 222 included in the video stream 160 to generate the custom video stream 230.

As shown, the layer decoding engine 250 performs any number and/or types of decoding operations on the custom video stream 230 to generate decoded layers 260. The decoded layers 260 include, without limitation, a decoded base layer 262, a decoded texture enhancement layer 264, and a decoded alpha enhancement layer 266. The decoded base layer 262 is a decoded version of the base layer 222. The decoded texture enhancement layer 264 is a decoded version of the texture enhancement layer 214. The decoded alpha enhancement layer 266 is a decoded version of the alpha enhancement layer 216.

As shown, the blending engine 270 generates the custom video feed 182(1) based on the decoded layers 260 and the blending metadata 218. More precisely, the blending engine 270 performs one or more blending operations on the decoded base layer 262 and the decoded texture enhancement layer 264 using the decoded alpha enhancement layer 266 as per the blending metadata 218 to generate the custom video feed 182(1).

As noted previously herein, in some embodiments, the blending metadata 218 indicates a type of alpha blending process that is to be performed on the decoded base layer 262 and the decoded texture enhancement layer 264 using the decoded alpha enhancement layer 266. Together, the decoded alpha enhancement layer 266 and the blending metadata 218 define the relative transparency of each sample of each frame of the decoded texture enhancement layer 264 when blended with a corresponding sample of a corresponding frame of the decoded base layer 262.

The blending metadata 218 can indicate any type of alpha blending process in any technically feasible fashion. In some embodiments, the blending metadata indicates a combination of a type of alpha blending process and a color space. The blending engine 270 applies the indicated alpha blending process in the indicated color space to blend each sample of each frame included in the decoded texture enhancement layer 264 with a corresponding sample of a corresponding frame included in the decoded base layer 262 using an associated sample of a corresponding frame included in the decoded alpha enhancement layer 266.

For instance, in some embodiments, the blending metadata 218 specifies a premultiplied alpha blending process in the YCbCr color space. The blending engine 270 can implement the following equations (1a)-(1f) to compute samples for a new “display” frame to be added to the custom video feed 182(1) using the premultiplied alpha blending process in the YCbCr color space.

$$alphaRange = Abs ( alphaOpaque - alphaTransparent ) \qquad ( 1 a )$$

$$alphaB = Abs ( ay - alphaOpaque ) \qquad ( 1 b )$$

$$dy = ty + ( alphaB \times by + alphaRange / 2 ) / alphaRange \qquad ( 1 c )$$

$$dCb = tCb + ( alphaB \times bCb + alpharange / 2 ) / alphaRange \qquad ( 1 d )$$

$$dCr = tCr + ( alphaB \times bCr + alphaRange / 2 ) / alphaRange \qquad ( 1 e )$$

In equations (1a)-(1e), alphaOpaque denotes an alpha value (e.g., 255) indicating fully opaque; alphaTransparent denotes an alpha value (e.g., 0) indicating fully transparent; dY, dCb, and dCr denote respectively, Y, Cb, and Cr samples for the new display frame; ay denotes a corresponding Y sample from a corresponding frame included in the decoded alpha enhancement layer 266; ty, tCb, and tCr denote, respectively, corresponding Y, Cb, and Cr samples from a corresponding frame included in the decoded texture enhancement layer 264; and by, bCb, and bCr denote, respectively, corresponding Y, Cb, and Cr samples from a corresponding frame included in the decoded base layer 262.

In some other embodiments, the blending metadata 218 indicates a straight alpha blending process in the YCbCr color space. The blending engine 270 can implement the following equations (2a)-(2f) to compute samples for a new display frame to be added to the custom video feed 182(1) using the straight alpha blending process in the YCbCr color space.

$$alphaRange = Abs ( alphaOpaque - alphaTransparent ) \qquad ( 2 a )$$

$$alphaT = Abs ( ay - alphaTransparent ) \qquad ( 2 b )$$

$$alphaB = Abs ( ay - alphaOpaque ) \qquad ( 2 c )$$

$$dy = ( alphaT \times ty + alphaB \times by + alphaRange / 2 ) / alphaRange \qquad ( 2 d )$$

$$dCb = ( alphaT \times tCb + alphaB \times bCb + alphaRange / 2 ) / alphaRange \qquad ( 2 e )$$

$$dCr = ( alpha \times tCr + alphaB \times bCr + alphaRange / 2 ) / alphaRange \qquad ( 2 f )$$

In equations (2a)-(2f), alphaOpaque denotes an alpha value indicating fully opaque; alphaTransparent denotes an alpha value indicating fully transparent; dY, dCb, and dCr denote respectively, Y, Cb, and Cr samples for the new display frame; ay denotes a corresponding Y sample from a corresponding frame included in the decoded alpha enhancement layer 266; ty, tCb, and tCr denote, respectively, corresponding Y, Cb, and Cr samples from a corresponding frame included in the decoded texture enhancement layer 264; and by, bCb, and bCr denote, respectively, corresponding Y, Cb, and Cr samples from a corresponding frame included in the decoded base layer 262.

In yet other embodiments, the blending metadata 218 indicates a straight alpha blending process in the RGB color space. The blending engine 270 can implement the following equations (3a)-(3j) to compute samples for a new display frame to be added to the custom video feed 182(1) using the straight alpha blending process in the RGB color space.

$$alphaRange = Abs ( alphaOpaque - alphaTransparent ) \qquad ( 3 a )$$

$$alphaTr = Abs ( ar - alphaTransparent ) \qquad ( 3 b )$$

$$alphaBr = Abs ( ar - alphaOpaque ) \qquad ( 3 c )$$

$$alphaTg = Abs ( ag - alphaTransparent ) \qquad ( 3 d )$$

$$alphaBg = Abs ( ag - alphaOpaque ) \qquad ( 3 e )$$

$$alphaTb = Abs ( ab - alphaTransparent ) \qquad ( 3 f )$$

$$alphaBb = Abs ( ab - alphaOpaque ) \qquad ( 3 g )$$

$$dr = ( alphaTr \times tr + alphaBr \times br + alphaRange / 2 ) / alphaRange \qquad ( 3 h )$$

$$dg = ( alphaTg \times tg + alphaBg \times bg + alphaRange / 2 ) / alphaRange \qquad ( 3 i )$$

$$db = ( alphaTb \times tb + alphaBb \times bb + alphaRange / 2 ) / alphaRange \qquad ( 3 j )$$

In equations (3a)-(3j), alphaOpaque denotes an alpha value indicating fully opaque; alphaTransparent denotes an alpha value indicating fully transparent; dr, dg, and db denote respectively, R, G, and B samples for the new display frame; ar, ag, and ab denote respectively, corresponding R, G, and B samples from a corresponding frame included in the decoded alpha enhancement layer 266; tr, tg, and tb denote, respectively, corresponding R, G, and B samples from a corresponding frame included in the decoded texture enhancement layer 264; and br, bg, and bb denote, respectively, corresponding R, G, and B samples from the corresponding frame included in the decoded base layer 262.

Importantly, as described previously herein, the custom decoding application 180(1) incrementally generates the custom video feed 182(1) during the live event in real-time or near real-time. The custom decoding application 180(1) can implement any number and/or types of techniques to incrementally generate the custom video feed 182(1).

For instance, in some embodiments, prior to the live event, the custom decoding application 180 acquires the custom stream definition 162(1). After the live event starts, the custom decoding application 180 acquires the blending metadata 218 and generates an initial portion of the custom video stream 230 that includes at least the blending metadata 218 as per the custom stream definition 162(1). As each new segment of the video stream 160 becomes available, the custom decoding application 180(1) acquires the new segment of the video stream 160 and a corresponding segment of the enhancement stream 130(1). The custom decoding application 180(1) generates a new segment of the custom video stream 230 in accordance with the custom stream definition 162(1) based on the new segment of the video stream 160 and the corresponding segment of the enhancement stream 130(1). The layer decoding engine 250 performs one or more decoding operations on the new segment of the custom video stream 230 to generate a new portion of the decoded layers 260. The blending engine 270 performs one or more alpha blending operations on the new portion of the decoded layers 260 as per the blending metadata 218 to generate a new portion of the custom video feed 182(1).

Note that the techniques described herein are illustrative rather than restrictive and can be altered without departing from the broader spirit and scope of the invention. Many modifications and variations on the functionality of the scalable encoding application 120, the manifest application 152, the custom decoding application 180(1), the layer decoding engine 250, and the blending engine 270 as described herein will be apparent to those of ordinary skill in the art without departing from the scope and spirit of the described embodiments.

Similarly, many modifications and variations on storage and delivery of the base layer 222, the texture enhancement layer 214, the alpha enhancement layer 216, the blending metadata 218, and the custom stream definition 162(1) to the custom decoding application 180(1) as described herein will be apparent to those of ordinary skill in the art without departing from the scope and spirit of the described embodiments.

In some alternate embodiments, the enhancement stream 130(1) includes the texture enhancement layer 214 and at least one of the blending metadata 218 or the alpha enhancement layer 216. The custom stream definition 162(1) specifies that the custom video stream 230 is to include the base layer 222 from the video stream 160, the texture enhancement layer 214 from the enhancement stream 130(1), and at least one of the blending metadata 218 from the enhancement stream 130(1) or the alpha enhancement layer 216 from the enhancement stream 130(1). The custom decoding application 180(1) aggregates the base layer 222, the texture enhancement layer 214, and at least one of the alpha enhancement layer 216 or the blending metadata 218 to generate the custom video stream 230. The layer decoding engine 250 generates the decoded layers 260 that include the decoded base layer 262, the decoded texture enhancement layer 264, and optionally the decoded alpha enhancement layer 266. The blending engine 270 performs any number and/or types of blending operations between the decoded base layer 262 and the decoded texture enhancement layer 264 using a least one of the decoded alpha enhancement layer 266 or the blending metadata 218 to generate the custom video feed 182(1).

FIG. 3 is a more detailed illustration of the transcoding cluster 190 of FIG. 1, according to various embodiments. As described previously herein in conjunction with FIG. 1, the transcoding cluster 190 generates and stores in the CDN 140 the integrated video stream 192(1)—the integrated video stream 192(N) based on the video stream 160, the enhancement stream 130(1)—the enhancement stream 130(N), and the custom stream definition 162(1)—the custom stream definition 162(N).

As shown, in some embodiments, the transcoding cluster 190 includes, without limitation, a cluster memory 340 and a compute instance 310(1)—a compute instance 310(N). The cluster memory 340 can include any number and/or types of memory that are available to the compute instance 310(1)—the compute instance 310(N). Referring back to FIG. 1, prior to the live event, the scalable encoding application 120(1)—the scalable encoding application 120(N) transmit the enhancement streams 130 to the transcoding cluster 190. The transcoding cluster 190 stores the enhancement streams 130 in the cluster memory 340.

The compute instance 310(1)—the compute instance 310(N) are also referred to herein individually as a “compute instance 310” and collectively as “compute instances 310.” Any number of the compute instances 310(0)—the compute instance 310(N) can be implemented in a cloud computing environment, implemented as part of any other distributed computing environment, or implemented in a stand-alone fashion.

As shown, in some embodiments, the compute instance 310(1) includes, without limitation, a processor 312(1) and a memory 316(1). As also shown, the compute instance 310(N) includes, without limitation, a processor 312(N) and a memory 316(N). Although not shown, each of the compute instance 310(2)—the compute instance 310(N−1) includes, without limitation, at least one processor and at least one memory. In some embodiments, each compute instance 310 can include any number of processors 312 and any number of memories 316 in any combination. In particular, any number of compute instances 310 (including one) can provide any number of multiprocessing environments in any technically feasible fashion. The processor 312(1), the processor 312(N), and any other processors included in the compute instances 310 are also referred to herein individually as a “processor 312” and collectively as “processors 312.” The memory 316(1), the memory 316(N), and any other memories included in the compute instances 310 are also referred to herein individually as a “memory 316” and collectively as “memories 316.”

Each processor 312 can be any instruction execution system, apparatus, or device capable of executing instructions. The memory 316 of each compute instance 310 stores content, such as software applications and data, for use by the processor 312 of the compute instance 310. Each memory 316 can be one or more of any readily available memory, such as random access memory, read-only memory, floppy disk, hard disk, or any other form of digital storage, local or remote.

In general, each of the compute instances 310 is configured to implement one or more software applications. As shown, in some embodiments, a custom decoding application 380(1) and an encoding application 388(1) reside in the memory 316(1) of the compute instance 310(1) and execute on the processor 312(1) of the compute instance 310(1). As also shown, a custom decoding application 380(N) and an encoding application 388(N) reside in the memory 316(N) of the compute instance 310(N) and execute on the processor 312(N) of the compute instance 310(N). Although not shown, for a variable integer x from 2 through N−1, a custom decoding application 380(x) and an encoding application 388(x) reside in a memory 316(x) of the compute instance 310(x) and execute on a processor 312(x) of the compute instance 310(x).

The custom decoding application 380(1)—the custom decoding application 380(N) are different instances of a custom decoding application 380 (not explicitly shown). The custom decoding application 380 is substantially similar to the custom decoding application 180 described previously herein in conjunction with FIG. 1 and therefore the custom decoding application 180(1) described in detail previously herein in conjunction with FIG. 2. In some embodiments, the custom decoding application 180(1)—the custom decoding application 180(N) and the custom decoding application 380(1)—the custom decoding application 380(N) are different instances of the same custom decoding application. For explanatory purposes, “the custom decoding application 180/380” is equivalent to “the custom decoding application 180 or the custom decoding application 380.”

Prior to the live event, the manifest application 152 (not shown in FIG. 3) transmits the custom stream definition 162(1)—the custom stream definition 162(N) to, respectively, the custom decoding application 380(1)—the custom decoding application 380(N). Throughout the live event, the scalable encoding application 120(0) transmits segments of the video stream 160 to the custom decoding application 380(1)—the custom decoding application 380(N). Upon receiving each segment of the video stream 160, the custom decoding application 380(1)—the custom decoding application 380(N) retrieves from the cluster memory 340 a corresponding segment of, respectively, the enhancement stream 130(1)—the enhancement stream 130(N). In this fashion, the custom decoding application 380(1)—the custom decoding application 380(N) acquire, respectively, the custom stream definition 162(1)—the custom stream definition 162(N), incrementally acquire the video stream 160, and incrementally acquire, respectively, the enhancement stream 130(1)—the enhancement stream 130(N).

Throughout the live event, the custom decoding application 380(1)—the custom decoding application 380(N) generate, respectively, a custom video feed 382(1)—a custom video feed 382(N) in accordance with, respectively, the custom stream definition 162(1)—the custom stream definition 162(N). Notably, for a variable integer y from 1 through N, the blending metadata included in the enhancement stream 130(y) and the alpha enhancement layer included in the enhancement stream 130(y) specify how to combine the base layer included in the video stream 160 and the texture enhancement layer specified in the enhancement stream 130(y) during decoding to generate the custom video feed 382(y).

The encoding application 388(1)—the encoding application 388(N) are different instances of an encoding application 388 (not explicitly shown). As shown, throughout the live event, the encoding application 388(1)—the encoding application 388(N) incrementally generate and store in the CDN 140, respectively, the integrated video stream 192(1)—the integrated video stream 192(N) based on, respectively, the custom video feed 382(1)—the custom video feed 382(N).

More precisely, as shown, the encoding application 388(1) performs one or more encoding operations on the custom video feed 382(1) to incrementally generate the integrated video stream 192(1) and incrementally stores the integrated video stream 192(1) in the CDN 140. As also shown, the encoding application 388(N) performs one or more encoding operations on the custom video feed 382(N) to incrementally generate the integrated video stream 192(N) and incrementally stores the integrated video stream 192(N) in the CDN 140. Although not shown, for a variable integer x from 2 through N−1, the encoding application 388(x) performs one or more encoding operations on the custom video feed 382(x) to incrementally generate the integrated video stream 192(x) and incrementally stores the integrated video stream 192(x) in the CDN 140

In some alternate embodiments, the cluster memory 340 is included in the CDN 140 and the techniques described herein are modified accordingly. In some alternate embodiments, any portion (including all) of the functionality of custom decoding application 380 and any portion (including all) of the functionality of the encoding application 388 is integrated into a transcoding application (not shown), and the techniques described herein are modified accordingly.

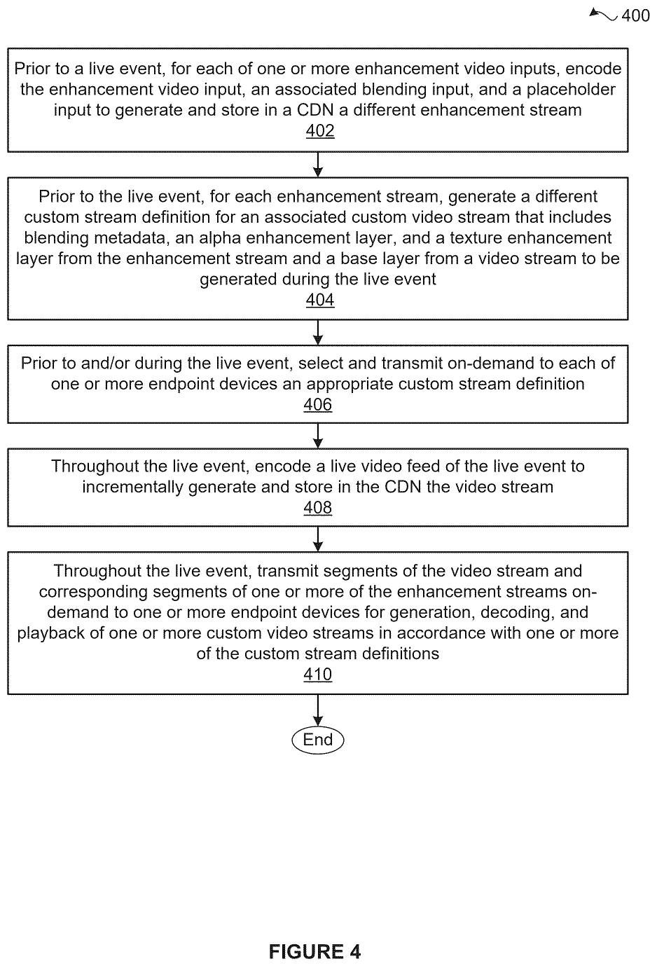

FIG. 4 is a flow diagram of method steps for integrating custom advertising into custom video feeds when streaming live events, according to various embodiments. Although the method steps are described with reference to the systems of FIGS. 1-2, persons skilled in the art will understand that any system configured to implement the method steps, in any order, falls within the scope of the various embodiments.

As shown, a method 400 begins at step 402, where, prior to a live event, for each of one or more enhancement video inputs, scalable encoding application 120 encodes the enhancement video input, an associated blending input, and a placeholder input to generate and store in the CDN 140 a different enhancement stream.

At step 404, prior to the live event, for each enhancement stream, the manifest application 152 generates a different custom stream definition for an associated custom video stream that includes blending metadata, an alpha enhancement layer, and a texture enhancement layer from the enhancement stream and a base layer from video stream 160 to be generated during the live event. At step 406, prior to and/or during the live event, the manifest application 152 selects and transmits on-demand to each of one or more endpoint devices an appropriate custom stream definition.

At step 408, throughout the live event, the scalable encoding application 120 encodes live video feed 150 of the live event to incrementally generate and store in the CDN 140 the video stream 160. At step 410, throughout the live event, the CDN 140 transmits segments of the video stream 160 and corresponding segments of one or more of the enhancement streams on-demand to one or more endpoint devices for generation, decoding, and playback of one or more custom video streams in accordance with one or more of the custom stream definitions. The method 400 then terminates.

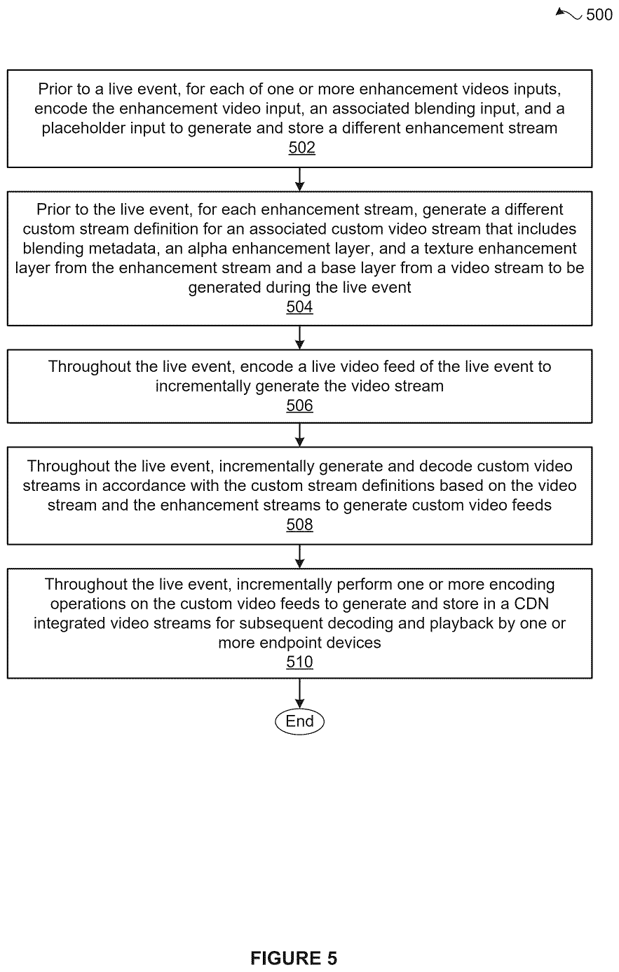

FIG. 5 is a flow diagram of method steps for generating different integrated video streams corresponding to different enhancement streams when streaming live events, according to various embodiments. Although the method steps are described with reference to the systems of FIGS. 1-3, persons skilled in the art will understand that any system configured to implement the method steps, in any order, falls within the scope of the various embodiments.

As shown, a method 500 begins at step 502, where, prior to a live event, for each of one or more enhancement video inputs, scalable encoding application 120 encodes the enhancement video input, an associated blending input, and a placeholder input to generate and store a different enhancement stream.

At step 504, prior to the live event, for each enhancement stream, manifest application 152 generates a different custom stream definition for an associated custom video stream that includes blending metadata, an alpha enhancement layer, and a texture enhancement layer from the enhancement stream and a base layer from video stream 160 to be generated during the live event. At step 506, throughout the live event, the scalable encoding application 120 encodes live video feed 150 of the live event to incrementally generate the video stream 160.

At step 508, throughout the live event, the custom decoding application 380 incrementally generates and decodes custom video streams in accordance with the custom stream definitions based on the video stream 160 and the enhancement streams to generate custom video feeds. At step 510, throughout the live event, the encoding application 388 incrementally performs one or more encoding operations on the custom video feeds to generate and store in CDN 140 integrated video streams for subsequent decoding and playback by one or more endpoint devices. The method 500 then terminates.

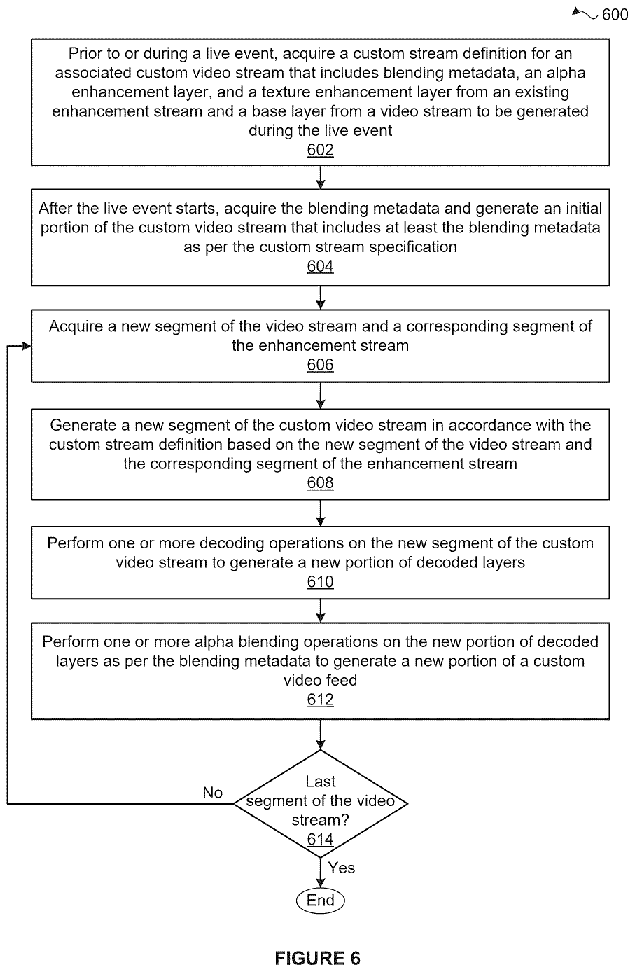

FIG. 6 is a flow diagram of method steps for decoding a video stream and an enhancement stream to generate a custom video feed, according to various embodiments. Although the method steps are described with reference to the systems of FIGS. 1-3, persons skilled in the art will understand that any system configured to implement the method steps, in any order, falls within the scope of the various embodiments.

As shown, a method 600 begins at step 602, where, prior to or during a live event, the custom decoding application 180/380 acquires a custom stream definition for an associated custom video stream that includes blending metadata, an alpha enhancement layer, and a texture enhancement layer from an existing enhancement stream and a base layer from video stream 160 to be generated during the live event. At step 604, after the live event starts, the custom decoding application 180/380 acquires the blending metadata and generates an initial portion of the custom video stream that includes at least the blending metadata as per the custom stream definition.

At step 606, the custom decoding application 180/380 acquires a new segment of the video stream 160 and a corresponding segment of the enhancement stream. At step 608, the custom decoding application 180/380 generates a new segment of the custom video stream in accordance with the custom stream definition based on the new segment of the video stream 160 and the corresponding segment of the enhancement stream.

At step 610, the custom decoding application 180/380 performs one or more decoding operations on the new segment of the custom video stream to generate a new portion of decoded layers. At step 612, the custom decoding application 180/380 performs one or more alpha blending operations on the new portion of decoded layers as per the blending metadata to generate a new portion of a custom video feed.

At step 614, the custom decoding application 180/380 determines whether the new segment of the video stream 160 is the last segment of the video stream 160. If, at step 614, the custom decoding application 180/380 determines that the new segment of the video stream 160 is not the last segment of the video stream 160, then the method 600 returns to step 606, where the custom decoding application 180/380 acquires a new segment of the video stream 160 and a corresponding segment of the enhancement stream.

If, however, at step 614, the custom decoding application 180/380 determines that the new segment of the video stream 160 is the last segment of the video stream 160, then the method 600 terminates.

In sum, the disclosed techniques can be used to generate different custom video feeds that enable a live event to be played back on various endpoint devices with integrated advertising that is tailored for different target audiences. In some embodiments, prior to the live event, multiple instances of a scalable encoding application generate and store in a CDN different enhancement streams based on different enhancement video inputs, different blending inputs, and a placeholder input. For each enhancement stream, a manifest application generates a custom stream definition for a custom video stream that includes blending metadata, an alpha enhancement layer, and a texture enhancement layer from the enhancement stream and a base layer from a video stream to be generated during the live event. During the live event, an instance of a scalable encoding application incrementally generates and stores in the CDN a video stream based on a live video feed of the live event.

To stream the live event to a compliant endpoint device, a custom decoding application executing on the compliant endpoint device acquires one of the custom stream definitions. During the live event, the custom decoding application incrementally retrieves from the CDN the video stream and the enhancement stream specified in the custom stream definition. The custom decoding application incrementally generates a custom video stream in accordance with the custom stream definition. The custom decoding application incrementally performs decoding operations on the custom video stream to incrementally generate decoded layers. The custom decoding application incrementally performs one or more blending operations on the decoded layers as per the blending metadata to incrementally generate a custom video feed. A playback application executing on the compliant endpoint device incrementally plays back the custom video feed.

Optionally, a transcoding cluster incrementally generates and stores in the CDN integrated video streams during the live event in accordance with the custom stream definitions. More precisely, for each custom stream definition, a different instance of the custom decoding application executing in the transcoding cluster incrementally generates a different custom video feed based on the video stream and the enhancement stream specified in the custom stream definition. Any number of instances of an encoding application executing in the transcoding cluster incrementally encode the custom video feeds to incrementally generate and store in the CDN integrated video streams. To stream the live event, a conventional decoding application executing on a non-compliant endpoint device incrementally retrieves from the CDN and decodes one of the integrated video streams to incrementally generate a custom video feed. A playback application executing on the non-compliant endpoint device incrementally plays back the custom video feed.

At least one technical advantage of the disclosed techniques relative to the prior art is that, with the disclosed techniques, different advertising video inputs can be encoded prior to a live event and then individually blended with a video stream during the live event to generate different custom video streams for the live event. In that regard, only a single live video feed is encoded during the live event in order to generate any number of custom video streams. Consequently, stream delays introduced when generating the custom video streams can be significantly reduced relative to prior art techniques. Another advantage of the disclosed techniques is that because a substantially greater number of custom video streams for a live event can be generated in real-time or near real-time, the likelihood that the preferences of individual users are reflected in the custom video streams can be increased. More specifically, with the disclosed techniques, each different encoded advertising input is transmitted along with the video stream to any number of compliant endpoint devices associated with a target audience for that particular encoded advertising input, where each “compliant” endpoint device is capable of generating, decoding, and playing back a corresponding custom video stream. And, with the disclosed techniques, each custom video stream can be generated and transcoded, where the resulting transcoded video stream can be transmitted to any number of less capable, non-compliant endpoint devices for decoding and playback. Furthermore, unlike some prior-art techniques, the disclosed techniques allow frame-accurate rendering of graphics. In that regard, using prior-art techniques that involve placing overlay graphics on top of live video feeds, the accuracy of frame synchronization can be achieved typically in milli-second accuracy, not per-frame accuracy. These technical advantages provide one or more technical advancements over prior art approaches.

1. In some embodiments, a computer-implemented method for generating custom video feeds for live events comprises prior to a first live event, generating a plurality of enhancement streams based on a plurality of enhancement video inputs; during the first live event, generating a first video stream based on a first live video feed of the first live event; during the first live event, transmitting the first video stream and a first enhancement stream included in the plurality of enhancement streams to a first endpoint device, wherein the first endpoint device generates and plays back a first custom video feed associated with the first live event; and during the first live event, transmitting the first video stream and a second enhancement stream included in the plurality of enhancement streams to a second endpoint device, wherein the second endpoint device generates and plays back a second custom video feed associated with the first live event.

2. The computer-implemented method of clause 1, wherein generating the plurality of enhancement streams comprises performing one or more encoding operations on an enhancement video input and at least one of a blending input or a placeholder input to generate the first enhancement stream.

3. The computer-implemented method of clauses 1 or 2, wherein the blending input includes at least one of per-pixel or per-sample transparency information associated with the enhancement video input.

4. The computer-implemented method of any of clauses 1-3, wherein the first enhancement stream includes an alpha enhancement layer, a texture enhancement layer, and a placeholder base layer.

5. The computer-implemented method of any of clauses 1-4, wherein generating the first video stream comprises performing one or more encoding operations on the first live video feed.

6. The computer-implemented method of any of clauses 1-5, wherein each enhancement video input included in the plurality of enhancement video inputs includes different advertising content.

7. The computer-implemented method of any of clauses 1-6, further comprising during a second live event, generating a second video stream based on a second live video feed of the second live event; during the second live event, transmitting the second video stream and the first enhancement stream to a third endpoint device, wherein the third endpoint device generates and plays back a third custom video feed associated with the second live event; and during the second live event, transmitting the second video stream and the second enhancement stream to a fourth endpoint device, wherein the fourth endpoint device generates and plays back a fourth custom video feed associated with the second live event.

8. The computer-implemented method of any of clauses 1-7, further comprising transmitting a first custom stream definition to the first endpoint device specifying that a first custom video stream is to include a base layer from the first video stream, first blending metadata from the first enhancement stream, a first alpha enhancement layer from the first enhancement stream, and a first texture enhancement layer from the first enhancement stream, wherein the first endpoint device generates the first custom video stream for decoding and playback in accordance with the first custom stream definition.

9. The computer-implemented method of any of clauses 1-8 wherein the first blending metadata indicates a blending process that is to be performed between a decoded version of the base layer and a decoded version of the first texture enhancement layer based on a decoded version of the first alpha enhancement layer when decoding the first custom video stream.

10. The computer-implemented method of any of clauses 1-9, further comprising transmitting a second custom stream definition to the second endpoint device specifying that a second custom video stream is to include the base layer, second blending metadata from the second enhancement stream, a second alpha enhancement layer from the second enhancement stream, and a second texture enhancement layer from the second enhancement stream, wherein the second endpoint device generates the second custom video stream for decoding and playback in accordance with the second custom stream definition.

11. In some embodiments, one or more non-transitory computer readable media include instructions that, when executed by one or more processors, cause the one or more processors to generate custom video feeds for live events by performing the steps of prior to a first live event, generating a plurality of enhancement streams based on a plurality of enhancement video inputs; during the first live event, generating a first video stream based on a first live video feed of the first live event; during the first live event, transmitting the first video stream and a first enhancement stream included in the plurality of enhancement streams to a first endpoint device, wherein the first endpoint device generates and plays back a first custom video feed associated with the first live event; and during the first live event, transmitting the first video stream and a second enhancement stream included in the plurality of enhancement streams to a second endpoint device, wherein the second endpoint device generates and plays back a second custom video feed associated with the first live event.

12. The one or more non-transitory computer readable media of clause 11, wherein generating the plurality of enhancement streams comprises performing one or more encoding operations on an enhancement video input and at least one of a blending input or a placeholder input to generate the first enhancement stream.

13. The one or more non-transitory computer readable media of clauses 11 or 12, wherein the blending input includes transparency information associated with the enhancement video input.

14. The one or more non-transitory computer readable media of any of clauses 11-13, wherein the first enhancement stream includes an alpha enhancement layer, a texture enhancement layer, and a placeholder base layer.

15. The one or more non-transitory computer readable media of any of clauses 11-14, wherein generating the first video stream comprises performing one or more encoding operations on a portion of the first live video feed to generate a segment included in the first video stream.

16. The one or more non-transitory computer readable media of any of clauses 11-15, wherein the first custom video feed includes first integrated advertising, and the second custom video feed includes second integrated advertising.

17. The one or more non-transitory computer readable media of any of clauses 11-16, further comprising during a second live event, generating a second video stream based on a second live video feed of the second live event; during the second live event, transmitting the second video stream and the first enhancement stream to a third endpoint device, wherein the third endpoint device generates and plays back a third custom video feed associated with the second live event; and during the second live event, transmitting the second video stream and the second enhancement stream to a fourth endpoint device, wherein the fourth endpoint device generates and plays back a fourth custom video feed associated with the second live event.

18. The one or more non-transitory computer readable media of any of clauses 11-17, further comprising transmitting a first custom stream definition to the first endpoint device specifying that a first custom video stream is to include a base layer from the first video stream, first blending metadata from the first enhancement stream, a first alpha enhancement layer from the first enhancement stream, and a first texture enhancement layer from the first enhancement stream, wherein the first endpoint device generates the first custom video stream for decoding and playback in accordance with the first custom stream definition.

19. The one or more non-transitory computer readable media of any of clauses 11-18, wherein the first blending metadata and the first alpha enhancement layer specify how to combine the base layer and the first texture enhancement layer when decoding the first custom video stream.

20. In some embodiments, a system comprises one or more memories storing instructions and one or more processors coupled to the one or more memories that, when executing the instructions, perform the steps of prior to a first live event, generating a plurality of enhancement streams based on a plurality of enhancement video inputs; during the first live event, generating a first video stream based on a first live video feed of the first live event; during the first live event, transmitting the first video stream and a first enhancement stream included in the plurality of enhancement streams to a first endpoint device, wherein the first endpoint device generates and plays back a first custom video feed associated with the first live event; and during the first live event, transmitting the first video stream and a second enhancement stream included in the plurality of enhancement streams to a second endpoint device, wherein the second endpoint device generates and plays back a second custom video feed associated with the first live event.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating custom video feeds for live events, the method comprising:
prior to a first live event, generating a plurality of enhancement streams based on a plurality of enhancement video inputs;
during the first live event, generating a first video stream based on a first live video feed of the first live event;
during the first live event, transmitting the first video stream and a first enhancement stream included in the plurality of enhancement streams to a first endpoint device, wherein the first endpoint device generates and plays back a first custom video feed associated with the first live event; and
during the first live event, transmitting the first video stream and a second enhancement stream included in the plurality of enhancement streams to a second endpoint device, wherein the second endpoint device generates and plays back a second custom video feed associated with the first live event.

2. The computer-implemented method of claim 1, wherein generating the plurality of enhancement streams comprises performing one or more encoding operations on an enhancement video input and at least one of a blending input or a placeholder input to generate the first enhancement stream.

3. The computer-implemented method of claim 2, wherein the blending input includes at least one of per-pixel or per-sample transparency information associated with the enhancement video input.

4. The computer-implemented method of claim 1, wherein the first enhancement stream includes an alpha enhancement layer, a texture enhancement layer, and a placeholder base layer.

5. The computer-implemented method of claim 1, wherein generating the first video stream comprises performing one or more encoding operations on the first live video feed.

6. The computer-implemented method of claim 1, wherein each enhancement video input included in the plurality of enhancement video inputs includes different advertising content.

7. The computer-implemented method of claim 1, further comprising:
during a second live event, generating a second video stream based on a second live video feed of the second live event;
during the second live event, transmitting the second video stream and the first enhancement stream to a third endpoint device, wherein the third endpoint device generates and plays back a third custom video feed associated with the second live event; and
during the second live event, transmitting the second video stream and the second enhancement stream to a fourth endpoint device, wherein the fourth endpoint device generates and plays back a fourth custom video feed associated with the second live event.

8. The computer-implemented method of claim 1, further comprising transmitting a first custom stream definition to the first endpoint device specifying that a first custom video stream is to include a base layer from the first video stream, first blending metadata from the first enhancement stream, a first alpha enhancement layer from the first enhancement stream, and a first texture enhancement layer from the first enhancement stream, wherein the first endpoint device generates the first custom video stream for decoding and playback in accordance with the first custom stream definition.

9. The computer-implemented method of claim 8, wherein the first blending metadata indicates a blending process that is to be performed between a decoded version of the base layer and a decoded version of the first texture enhancement layer based on a decoded version of the first alpha enhancement layer when decoding the first custom video stream.

10. The computer-implemented method of claim 8, further comprising transmitting a second custom stream definition to the second endpoint device specifying that a second custom video stream is to include the base layer, second blending metadata from the second enhancement stream, a second alpha enhancement layer from the second enhancement stream, and a second texture enhancement layer from the second enhancement stream, wherein the second endpoint device generates the second custom video stream for decoding and playback in accordance with the second custom stream definition.

11. One or more non-transitory computer readable media including instructions that, when executed by one or more processors, cause the one or more processors to generate custom video feeds for live events by performing the steps of:
prior to a first live event, generating a plurality of enhancement streams based on a plurality of enhancement video inputs;
during the first live event, generating a first video stream based on a first live video feed of the first live event;
during the first live event, transmitting the first video stream and a first enhancement stream included in the plurality of enhancement streams to a first endpoint device, wherein the first endpoint device generates and plays back a first custom video feed associated with the first live event; and
during the first live event, transmitting the first video stream and a second enhancement stream included in the plurality of enhancement streams to a second endpoint device, wherein the second endpoint device generates and plays back a second custom video feed associated with the first live event.

12. The one or more non-transitory computer readable media of claim 11, wherein generating the plurality of enhancement streams comprises performing one or more encoding operations on an enhancement video input and at least one of a blending input or a placeholder input to generate the first enhancement stream.

13. The one or more non-transitory computer readable media of claim 12, wherein the blending input includes transparency information associated with the enhancement video input.

14. The one or more non-transitory computer readable media of claim 11, wherein the first enhancement stream includes an alpha enhancement layer, a texture enhancement layer, and a placeholder base layer.

15. The one or more non-transitory computer readable media of claim 11, wherein generating the first video stream comprises performing one or more encoding operations on a portion of the first live video feed to generate a segment included in the first video stream.

16. The one or more non-transitory computer readable media of claim 11, wherein the first custom video feed includes first integrated advertising, and the second custom video feed includes second integrated advertising.

17. The one or more non-transitory computer readable media of claim 11, further comprising:
during a second live event, generating a second video stream based on a second live video feed of the second live event;
during the second live event, transmitting the second video stream and the first enhancement stream to a third endpoint device, wherein the third endpoint device generates and plays back a third custom video feed associated with the second live event; and
during the second live event, transmitting the second video stream and the second enhancement stream to a fourth endpoint device, wherein the fourth endpoint device generates and plays back a fourth custom video feed associated with the second live event.

18. The one or more non-transitory computer readable media of claim 11, further comprising transmitting a first custom stream definition to the first endpoint device specifying that a first custom video stream is to include a base layer from the first video stream, first blending metadata from the first enhancement stream, a first alpha enhancement layer from the first enhancement stream, and a first texture enhancement layer from the first enhancement stream, wherein the first endpoint device generates the first custom video stream for decoding and playback in accordance with the first custom stream definition.

19. The one or more non-transitory computer readable media of claim 18, wherein the first blending metadata and the first alpha enhancement layer specify how to combine the base layer and the first texture enhancement layer when decoding the first custom video stream.

20. A system comprising:
one or more memories storing instructions; and
one or more processors coupled to the one or more memories that, when executing the instructions, perform the steps of:
prior to a first live event, generating a plurality of enhancement streams based on a plurality of enhancement video inputs;
during the first live event, generating a first video stream based on a first live video feed of the first live event;
during the first live event, transmitting the first video stream and a first enhancement stream included in the plurality of enhancement streams to a first endpoint device, wherein the first endpoint device generates and plays back a first custom video feed associated with the first live event; and
during the first live event, transmitting the first video stream and a second enhancement stream included in the plurality of enhancement streams to a second endpoint device, wherein the second endpoint device generates and plays back a second custom video feed associated with the first live event.
